(19) United States
(12) Patent Application Publication
(10) Pub. No.: US 2005/0144790 A1
(43) Pub. Date: Jul. 7, 2005

(54) Training knife

(76) Inventor: John N. Stanley JR., Richmond, VA (US)

Correspondence Address: Peter K. KONTLER;PH4, 4401 Gulf Shore Blvd. North, Naples, FL, 34103-3450, US

(21) Appl. No.: 10/973,497

(22) Filed: Oct. 26, 2004

Related U.S. Application Data
(60) Provisional application No. 60/514,676, filed on Oct. 27, 2003.

(51) Int. Cl. B26B 27/00

(52) U.S. Cl. 30/350; 30/340

(57) ABSTRACT

A training knife for use primarily by military and law enforcement personnel has a blade made of a damage-resistant lightweight material, such as polycarbonate, PETG or an acrylic substance. The finish of the blade is such that it enhances the blade's light refracting and/or light reflecting properties; this can be accomplished, for example, by resorting to an oscillating sanding machine, by applying to the blade one or more abrasive media at an elevated pressure and/or by tumbling the blade in an abrasive medium to thus etch the selected portion(s) of the surface of the blade. One end portion of a lanyard can be attached to the free end of the handle of the knife, and the other end portion of the lanyard can be provided with a loop which surrounds the wrist of one hand of the person using the knife.

### CROSS-REFERENCE TO RELATED CASE

The present application discloses the entire subject matter of my provisional patent application Ser. No. 60/514,676 filed Oct. 27, 2003 for “Training Knife”.

The disclosure of my above-identified provisional patent application, as well as that or those of any other publication or publications identified in the specification of the present application, are incorporated herein by reference.

### BACKGROUND OF THE INVENTION

The present invention relates to improvements in knives in general, and more particularly to improvements in so-called training knives which are used primarily by members of the military and of the law enforcement agencies to practice defensive and/or offensive actions. Such knives can but need not always be used with so-called lanyards which serve to attach the handles of the knives to the bodies (e.g., to the wrists) of the users.

Presently known training knives can be classified as follows:
(a) The first category encompasses knives having aluminum blades. A drawback of such knives is that they are relatively heavy and can cause the user unwanted pain due to pronounced force. As a rule, such knives have narrow blade edges which can create high pressures and pronounced pain. Their usefulness is limited due to pronounced pain as a result of metal-to-bone contact.
(b) The second category includes plastic training knives which are easily damaged, have no positive visual properties in that they fail to simulate the finish of an actual knife, and do not sufficiently resemble actual knives. The plastic materials of which such knives are made include polypropylene, polyethylene and polystyrene.
(c) The third category encompasses wooden training knives which exhibit the following drawbacks: they are readily scarred and/or otherwise damaged; they can produce splinters which can puncture the skin of a participant in actual use; they have no positive ocular properties, i.e., their finish fails to simulate that of an actual knife; and they do not resemble an actual knife.

At the time of filing of this application, applicant had knowledge of the following granted US patents and US patent application publications:
U.S. Pat. No. 5,174,756 granted Dec. 29, 1992 to Taylor for “Apparatus for simulating a sharp edged weapon”;
U.S. Pat. No. 6,352,465 B1 granted Mar. 5, 2002 to Heymann et al. for “Toy knife”;
U.S. Pat. No. 6,036,602 granted Mar. 14, 2000 to Abbott for “Full contact martial arts sparring instrument”;
U.S. Pat. No. 4,892,303 granted Jan. 9, 1990 to Lohre for “Sport fencing device”;
U.S. Pat. No. 6,487,756 B1 granted Dec. 3, 2002 to Vidal, Jr. for “Hand tool lanyard system”;
U.S. Pat. No. 5,207,363 granted May 4, 1993 to Duchi, Jr. et al. for “Lanyard”;
U.S. Pat. No. 4,982,522 granted Jan. 8, 1991 to Norton for “Gun safety lanyard;
U.S. Pat. No. 5,799,400 granted Sep. 1, 1998 to Glasser for “Folding knife with aperture to receive a lanyard”;
U.S. patent application publication No. U.S. 2004/0127292 A1 published Jul. 1, 2004 to Chen et al. for “Sparring weapon”;
U.S. patent application publication No. U.S. 2003/0195086 A1 published Oct. 16, 2003 to Hayes for “Edged weapon with substance distribution”; and
U.S. patent application publication No. U.S. 2004/0198173 A1 published Oct. 7, 2004 to Shulman et al. for “Sparring knife with marking system”.

The above-enumerated prior art is believed to have no bearing upon the patentability of claims which were filed with the present application.

### OBJECTS OF THE INVENTION

An important object of the present invention is to provide a simple and inexpensive training knife which overcomes the aforediscussed drawbacks of conventional training knives.

Another object of my invention is to provide a training knife which can be readily attached to the hand of the user in a simple, time-saving and inexpensive manner.

A further object of the instant invention is to provide a novel and improved method of finishing the blade of the improved training knife.

An additional object of the invention is to provide a lightweight training knife which is designed in a manner to avoid the application of pronounced striking forces.

Still another object of the invention is to provide a training knife which is designed to exhibit a wide striking surface and to thus reduce pressure when contacting a target.

Another object of the invention is to provide a training knife which renders it possible to perform realistic training in that it can closely resemble an actual knife.

An ancillary object of the present invention is to provide a highly damage-resistant training knife.

Another object of this invention is to provide a training knife with a blade having highly desirable optical properties.

### SUMMARY OF THE INVENTION

One feature of the present invention resides in the provision of a training or sparring knife which comprises a handle and a blade. At least a portion of the blade consists of a damage-resistant lightweight material and has a wide striking surface.

At least the aforementioned portion of the blade can consist of a material which is selected from the group consisting of polycarbonate, glycol-modified polyethylene terephthalate and an acrylic plastic material.

The improved knife can further comprise a lanyard which includes a first end portion separably connectable to a body part (such as the wrist) of the user of the knife and a second end portion, as well as means for connecting the second end portion of the lanyard to the handle of the knife. The connecting means can comprise a split ring, a snap swivel or a quick disconnect device.

At least a portion of the surface of the blade can be provided with a frosted finish which imparts to the blade ocular properties including refraction and/or reflection of light.

The aforementioned striking surface of the blade can be arranged to reduce pressure when contacting a target. Furthermore, the blade can be configurated to closely resemble the blade of an actual knife.

The aforementioned portion of the blade can consist of a lightweight damage-resistant material other than aluminum and/or wood.

The knife can further comprise a length of suitable (such as flexible) material which is convoluted over a portion or a major part of the handle. The flexible material can consist of parachute cord, adhesive grip tape or an analogous grip-enhancing substance.

In lieu of flexible material, the improved knife can comprise layers of carbon fiber which surround at least a portion of the handle. Furthermore, the grip-enhancing substance can comprise heat-shrinkable tubing which surrounds at least a portion of the handle.

Another feature of the present invention resides in the provision of a method of making a training or sparring knife including a handle and a blade which latter is provided with an exposed surface. The improved method comprises the steps of making at least a portion of the blade of a lightweight material, and imparting to at least a portion of the surface of the blade important ocular properties including at least one of (a) pronounced refraction of light and (b) pronounced reflection of light.

The imparting step can include providing the aforementioned portion of the surface of the blade with a frosted finish which is arrived at by at least one of the undertakings including resort to an oscillating sanding machine, applying to the aforementioned portion of the surface abrasive media at an elevated pressure and tumbling the aforementioned portion of the surface in at least one abrasive medium to thus etch such portion of the surface.

The lightweight material can be selected from the group consisting of polycarbonates, glycol-modified polyethylene terephthalate and an acrylic plastic material.

The method can further comprise the step of attaching one end portion of an elongated lanyard to the handle of the improved knife and providing the other end portion of the lanyard with means (e.g., a variable loop) for separably affixing the lanyard to the body (e.g., to one wrist) of a user of the knife. For example, the length of the lanyard between its end portions can be in the range of between about 8″ and 15″.

The novel features which are considered as characteristic of the invention are set forth in particular in the appended claims. The improved training knife itself, however, both as to its construction and the method of making and assembling the same, together with numerous additional important and advantageous features and attributes thereof, will be best understood upon perusal of the following detailed description of certain presently preferred specific embodiments with reference to the accompanying drawing.

### BRIEF DESCRIPTION OF THE DRAWING

FIG. 1 is an elevational view of a training knife which embodies one form of the present invention; and

FIG. 2 is an elevational view of a lanyard which can be utilized with the knife of FIG. 1.

### DESCRIPTION OF PREFERRED EMBODIMENTS

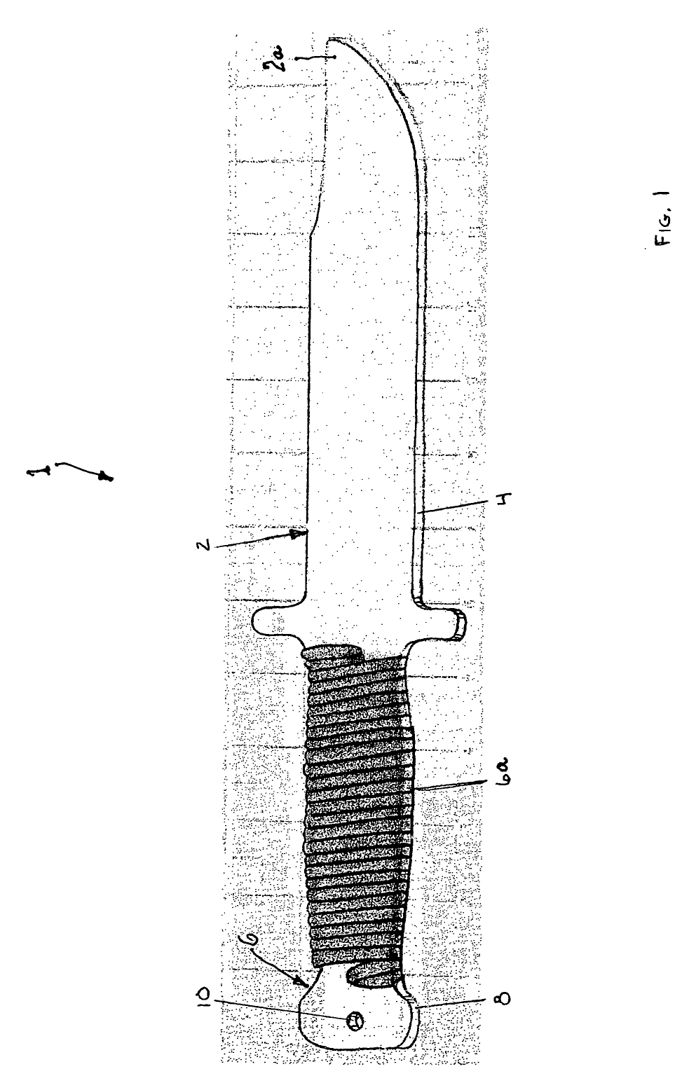

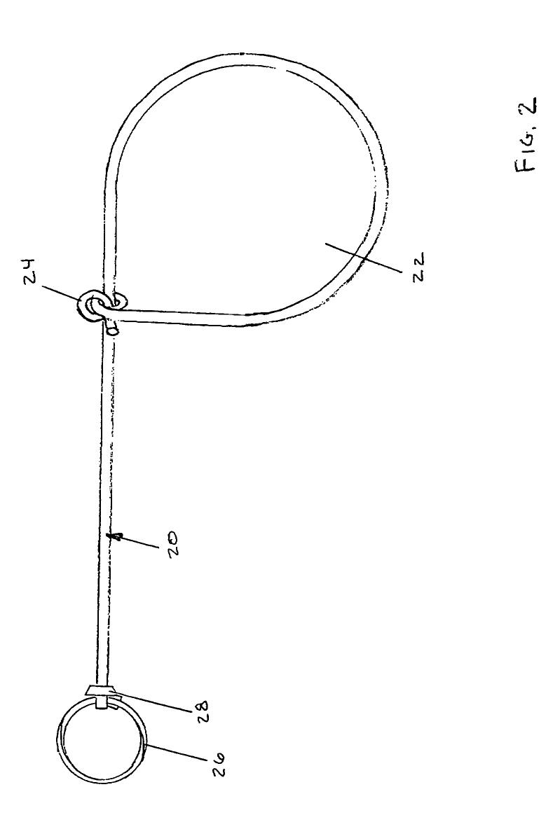

FIG. 1 shows a training or sparring knife 1 having a relatively wide elongated blade 2 with an edge 4 and a tip 2a, and a handle 6 surrounded by a parachute cord 6a. The illustrated handle 6 is of one piece with the blade 2, and that end portion (8) thereof (known as handle butt end) which is remote from the blade is provided with an opening 10 (e.g., a round hole) for a portion of a split ring 26 (see FIG. 2) separably attached to one end portion of an optional elongated knife lanyard 20. The one end portion of the illustrated lanyard 20 is separably attached to the handle 6 by a split ring 26 and an overhead knot 28, and the other end portion of the lanyard is provided with a slip knot 24 which enables the user to make an adjustable opening 22 for the wrist of one hand of the user.

The overall length of the knife 1 can equal or approximate the length of a standard knife or a standard training knife, and the length of the lanyard 20 can be in the range of between 8 and 15 inches (±2 inches). This lanyard can be made of a flexible cord-like material known as paracord or paraline.

The thickness of the major portion of the blade 2 can be in the range of between 3/16″ and ⅝″, and each chamfer at the edge 4 can be between about 1/32″ and ⅛″ so that the width of the actual edge can be about ¼″. This reduces the likelihood of injury to the user or to the other contestant when the improved training knife is in actual use.

As already mentioned hereinbefore, the improved knife can be made of a lightweight material such as polycarbonate, PETG, an acrylic plastic substance or an analogous high-strength impact-resistant material. The exposed surfaces of the blade 2 have a frosted finish which can be imparted thereto in any one of a number of different ways including the utilization of an oscillating sanding machine, the utilization of abrasive media (such as sand) which are propelled against the blade at an elevated pressure, and tumbling the blade in a drum or another suitable receptacle containing one or more abrasive media adapted to etch the surface of the blade.

Certain presently preferred additional modifications of the improved training knife include the following:

The parachute cord 6a can be replaced with an adhesive grip tape, carbon fibers, such as graphite fibers having the size of human hair which can be woven together and fused in an epoxy resin (the resulting knife handle is lightweight, three-dimensional in appearance and superior to many other handle materials), an analogous substance or heat-shrinkable tubing which enables the user to properly grip the handle. It is also possible to employ handle material of epoxy filled with woven glass fibers; such handles are impervious to changes in temperature and can be tinted in many colors. Still further, it is possible to employ Micarta (trademark) which is a composite of linen and paper fabric in epoxy resin; such material is lightweight, durable and appealing to the eye and is adapted to be bead blasted or polished to change its appearance.

The split ring 26 can be affixed to the butt end 8 of the handle 6 by a so-called snap swivel, another quick-disconnect device or any other suitable fastener.

As a rule, the improved training or sparring knife is utilized as follows:

Typically two training partners confront each other and carry out a series of drills which involve striking and blocking with the knives and their hands. The knife can come into contact with the body parts of the opponent, e.g., with the wrists, arms, neck, torso, legs and the head. The reduced force and pressure exertable with the improved training knife allow for more realistic training with greatly reduced likelihood of causing pain to the user and/or to the opponent.

In the course of a drill, each of the training partners attempts to track the movements of the opponent's knife. The improved knife of the present invention renders it possible to track and to be aware of such movements due to its ocular properties, i.e., the surface of the knife blade reflects and refracts any available light.

Realistic training necessitates the use of knives having dimensions and shapes at least approaching and resembling those of knives carried by military persons, policemen, martial artists and/or certain civilians. The knife of the present invention can be furnished in any desired size and/or shape, depending upon the nature of training, the occupations of the persons desiring to perform such training and/or other parameters which are worthy of or which require consideration in order to ensure proper shaping, dimensioning and other desirable characteristics of the improved knife.

Proper training or drills with the improved knife can also involve disarming the opponent. Such undertaking can result in repeated dropping of the knife on the floor, and this can involve repeated travel of the knife through the air prior to actual landing. The purpose of the lanyard 20 is to reduce or eliminate the likelihood of such unintentional dropping of the knife because, even if the handle 6 is released by the hand of the respective training partner, the thus released knife remains suspended on the hand. This not only reduces the likelihood of injury to other persons in the vicinity but also reduces the likelihood of damage to neighboring objects and ensures that the training can be resumed without any delay or without appreciable delay.

By making the improved knife of any one of the above-enumerated presently preferred materials, the knife can be put to repeated use because such material is resistant to impacts and can stand long periods of wear without risking degradation, breakage and/or other undesirable occurrences.

Without further analysis, the foregoing will so fully reveal the gist of the present invention that others can, by applying current knowledge, readily adapt it for various applications without omitting features that, from the standpoint of prior art, fairly constitute essential characteristics of the generic and specific aspects of the above outlined contribution to the art of training knives and, therefore, such adaptations should and are intended to be comprehended within the meaning and range of equivalence of the appended claims.

1. A training knife comprising a handle and a blade, at least a portion of said blade consisting of a damage-resistant lightweight material and having a wide striking surface.

2. The knife of claim 1, wherein at least said portion of said blade consists of a material selected from the group consisting of polycarbonate, glycol-modified polyethylene terephthalate and an acrylic plastic material.

3. The knife of claim 1, further comprising a lanyard including a first end portion separably connectable to a body part of the user of the knife and a second end portion, and means for connecting said second end portion to said handle.

4. The knife of claim 3, wherein said connecting means comprises at least one of a split ring, a snap swivel and a quick disconnect device.

5. The knife of claim 1, wherein said blade includes a surface having a frosted finish imparting to the blade ocular properties including at least one of a (a) refraction of light and (b) reflection of light.

6. The knife of claim 1, wherein said surface is arranged to reduce pressure when contacting a target.

7. The knife of claim 1, wherein said blade is configurated to closely resemble the blade of an actual knife.

8. The knife of claim 1, wherein at least said portion of said blade consists of a lightweight damage-resistant material other than aluminum and wood.

9. The knife of claim 1, further comprising a length of a flexible material convoluted around a portion at least of said handle.

10. The knife of claim 9, wherein said flexible material consists of at least one of parachute cord, adhesive grip tape and analogous grip-enhancing substances.

11. The knife of claim 1, further comprising at least one layer of carbon fiber surrounding at least a portion of said handle.

12. The knife of claim 1, further comprising heat-shrinkable tubing surrounding at least a portion of said handle.

13. A method of making a training knife having a handle and a blade having an exposed surface, comprising the steps of:
making at least a portion of said blade of a lightweight material; and
imparting to at least a portion of said surface of the blade ocular properties including at least one of (a) pronounced refraction of light and (b) pronounced reflection of light.

14. The method of claim 13, wherein said imparting step includes providing said portion of said surface with a frosted finish arrived at by at least one of the undertakings including resort to an oscillating sanding machine, applying to said portion of said surface abrasive media at an elevated pressure, and tumbling said portion of said surface in at least one abrasive medium to thus etch said portion of said surface.

15. The method of claim 13, wherein said lightweight material is selected from the group consisting of polycarbonates, glycol-modified polyethylene terephthalate and an acrylic plastic material.

16. The method of claim 13, further comprising the step of attaching one end portion of an elongated lanyard to the handle and providing another end portion of the lanyard with means for separably affixing the lanyard to the body of a user of the knife.

17. The method of claim 16, wherein the length of the lanyard between said end portions thereof is within the range of between about 8″ and 15″.
